(19) United States
(12) Patent Application Publication
(10) Pub. No.: US 2015/0140377 A1
(43) Pub. Date: May 21, 2015

(54) BATTERY STRUCTURES

(71) Applicant: Waterford Battery Systems Inc., Deerfield Beach, FL (US)

(72) Inventors: Steve Waterford, Deerfield Beach, FL (US); Thomas R. Zwaska, Deerfield Beach, FL (US)

(21) Appl. No.: 14/517,777

(22) Filed: Oct. 17, 2014

Related U.S. Application Data
(60) Provisional application No. 61/892,400, filed on Oct. 17, 2013.
(60) Provisional application No. 61/892,401, filed on Oct. 17, 2013.
(60) Provisional application No. 61/940,791, filed on Feb. 17, 2014.

(51) Int. Cl. H01M 2/22; H01M 10/38; H01M 2/04; H01M 10/48; H01M 2/12

(52) U.S. Cl. CPC H01M 2/22; H01M 10/48; H01M 2/1264; H01M 10/488; H01M 2/04; H01M 2/0404; H01M 2/043; H01M 10/38; H01M 2220/30; H01M 2220/20
USPC 429/82; 429/72

(57) ABSTRACT

Battery structures are formed such that the use of wires and soldering is eliminated or reduced. The battery plates can be infused down their anode and the cathode edges with an electrically conductive epoxy or sealant that connects said plates to each other and takes the place of traditional copper wires. Additional connection channels, including those in the top structure, can be filled with electrically conductive materials to replace wires and make the necessary connections. The battery structures can be configured to create a dual voltage battery. The insertion of the battery plates is easily configured within the assembly process to achieve a variety of in-series or in-parallel connections thus varying the voltage and amperage to achieve a desired output, all within the same enclosure.

### CROSS-REFERENCES TO RELATED APPLICATIONS

This application claims priority to and benefits from U.S. provisional patent application Ser. No. 61/892,400 filed Oct. 17, 2013. This application also claims priority to and benefits from U.S. provisional patent application Ser. No. 61/892,401 filed Oct. 17, 2013. This application also claims priority to and benefits from U.S. provisional patent application Ser. No. 61/940,791 filed Feb. 17, 2014. The '400, '401, and '791 provisional applications are expressly incorporated herein by reference in their entirety.

### FIELD OF THE INVENTION

The present invention relates to batteries and, in particular, to battery structures that eliminate or reduce the need for solder joints and wires for internal electrical connections. The invention also relates to the creation of non-lithium-ion batteries; though battery chemistries using lithium ions can benefit from this approach as well. In some embodiments, additive manufacturing is used to create the battery structure, although the structures can also be manufactured using conventional approaches.

### BACKGROUND OF THE INVENTION

The use of batteries has become prevalent in today's high-tech world. According to LUX Research the market for energy storage in mobile applications will go from $28 billion in 2013 to $41 billion in 2018, excluding starter batteries, fixed installation batteries and super capacitors. Batteries are used to power everyday devices including laptops, tablets, smartphones, military devices, and increasingly electric cars. Unfortunately, while these devices have become exponentially more powerful and, as a result, require an increasing amount of energy to run, there have been very little corresponding advancements in battery technology.

The first battery was invented in the 1800's by Alessandro Volta. While there have been improvements over the years, the basic concept has not changed. Batteries work by converting stored chemical energy into electrical energy. At its most basic level, a battery has four main parts; a negative electrode (anode) that holds charged ions, a positive electrode (cathode) that holds discharged ions, an electrolyte that allows ions to move between the anode to the cathode during discharge (and in reversing during recharge) and two terminals that allow current to flow out from the battery to power a device.

When the circuit between the two terminals is complete, the battery produces electricity through a series of electromagnetic reactions between the anode, the electrolyte, and the cathode. The anode undergoes an oxidation reaction in which ions from the electrolyte combine with the anode producing a compound and releasing electrons. Simultaneously, the cathode goes through a reduction reaction in which the cathode and the free electrons combine to form compounds. This net flow of electrons from the anode to cathode creates electricity. The battery continues to create electricity until the cathode, the anode, or both run out of necessary ions.

In order to increase the voltage (the potential energy of the battery) individual battery cells can be connected in series, in traditional batteries, this can be accomplished by connecting battery plates internally via single-point solder joints or conductive-element-filled epoxies to a plurality of wires. The use of these wires has limited the type of materials that can be utilized for the cathode and anode. Furthermore, since the wires are attached at a single point, they can bottleneck the chemical reaction involved in recharging or discharging a battery.

Alternatively, one can increase a battery's capacity by connecting the individual cells in parallel. Again, in traditional batteries this has been accomplished by connecting battery plates internally via single-point solder joints or conductive-element-filled epoxies to a plurality of wires which limits the type of materials that can be utilized for the cathode and anode and creates a bottleneck with respect to the chemical reaction involved in recharging or discharging a battery.

Historically, mass produced batteries have been made of several different types of materials including but not exclusively; zinc, carbon, chloride, nickel, copper, mercury, lead, and silver. Each of these materials offers different tradeoffs in factors such as energy density, expense, environmental hazards, working temperatures, and longevity.

The last major development in battery chemistry occurred in the 1990's with the creation of the first lithium-ion batteries. Lithium-ion batteries were seen as a major improvement over earlier models since they had relatively high energy density, a very low rate of self-discharge, and did not require a periodic complete discharge to maintain full capacity. A large number of today's high-tech devices including laptops, tablets, smartphones, military devices and electric cars use some type of lithium-ion battery.

Despite the popularity of today's lithium-ion batteries, they do have several important limitations including:
(1) Being prone to thermal runaway and catching fire. This occurs when the battery is over charged or fully discharged and as a result experiences polarity switching. This issue is well documented and is one reason for the restriction of transporting lithium-ion batteries on planes. In an attempt to prevent or minimize damage from this problem, some lithium-ion batteries have been placed within metal encasements, often with coolant added, which adds weight and cost to the battery. Lithium-ion batteries also require battery monitoring systems to commonly limit the maxim battery charge to roughly 85-95% of its full capacity and limits its discharge to roughly 5%-15% of its full capacity. Not only does this decrease the usable energy storage of the battery, but this monitoring also increases the battery's cost when monitoring, connections and circuit boards are incorporated to maintain the battery charge within these ranges.
(2) While lithium-ion batteries are less prone to the memory effect than say nickel cadmium, they still are only rated to up to approximately 1,200 charge/discharge cycles. This is especially troublesome for use in items that are frequently being recharged such as electric cars, laptops, mission critical military applications and smartphones.
(3) Lithium is a relatively rare element and is expensive. Furthermore, lithium batteries are toxic and are expensive to dispose of properly as hazardous waste.
(4) High capacity lithium batteries take hours to fully charge due to the need of a second phase cycle.

While other materials have shown promise in replacing lithium based batteries, current battery structures limit their applicability. For example, the fact that battery cells have traditionally seen connected internally via single-point solder joints or conductive-element-filled epoxies to a plurality of wires has limited the use of some alternative materials.

### SUMMARY OF THE INVENTION

An internal battery structure comprises:
(a) a housing having a floor and a front wall, a back wall and a pair of oppositely disposed side walls extending upwardly from the floor and forming an internal compartment therebetween; and
(b) a plurality of spaced battery plate support walls extending inwardly and alternatingly from the housing side walls, each of the support walls comprising an enlarged portion on its periphery, the support walls defining a serpentine channel extending between the support walls.

In an embodiment of the internal battery structure, the support walls are oriented such that insertion of a battery plate having an optional electrically insulative strip alignable with the support wall enlarged portion electrically isolates interior portions of the serpentine channel disposed between the support wall enlarged portions from the remaining peripheral portions of the serpentine channel adjacent the housing side walls. The remaining peripheral portions of the serpentine channel are preferably finable with an electrically conductive material.

An internal battery structure comprises:
(a) a housing having a floor and a front wall, a back wall and a pair of oppositely disposed side walls extending upwardly from the floor and forming an internal compartment therebetween;
(b) a first battery zone within the housing internal compartment, the first battery zone comprising a plurality of spaced battery plate support walls alternatingly extending from the housing side walls to define a plurality of first zone serpentine channels;
(c) a second battery zone within the housing internal compartment, the second battery zone comprising a plurality of spaced battery plate support walls alternatingly extending from the housing side walls to define a plurality of second zone serpentine channels; and
(d) a separation wall for fluidly isolating the first zone serpentine channels from the second zone serpentine channels.

In an embodiment of the internal battery structure, each of the support walls comprises an enlarged portion on its periphery such that insertion of a battery plate having an optional electrically insulative strip alignable with the support wall enlarged portion electrically isolates interior portions of the serpentine channels disposed between the support wall enlarged portions from the remaining peripheral portions of the serpentine channels adjacent the housing side walls. The first battery zone and the second battery zone are preferably configured to generate different voltages. The first battery zone and the second battery zone are preferably configured to generate the same voltages. The interior portions of the serpentine channels disposed between the support wall enlarged portions are preferably fillable with a first electrically conductive material and the remaining peripheral portions of the serpentine channel are preferably fillable with a second electrically conductive material. The first and second electrically conductive materials are preferably the same electrically conductive material.

In an embodiment of the internal battery structure, one of the zones is oriented with respect to the housing such that a utility space is defined between the one of the zones and the housing. The internal battery structure preferably further comprises:
(a) battery management circuitry disposed within the utility space; and
(b) a diamagnetic sensor.

A battery top structure comprising:
(a) an enclosure for sealing an open portion of a battery having an interior structure comprising at least one electrode, the enclosure having a bottom surface facing the battery interior structure, an oppositely facing top surface comprising an electrode terminal, and an inset peripheral edge, interconnecting the enclosure top and bottom surfaces and facing the battery exterior;
(b) an enclosure with a channel formed within the enclosure, the channel extending within the enclosure to a bottom surface peripheral edge and capable of containing an electrically conductive material, the electrically conductive material capable of conducting electrical current between the electrode and the electrode terminal.

In an embodiment of the battery top structure, wherein the electrode is one of an anode and a cathode. Where the electrode is an anode, the battery interior structure further comprises a cathode, and the battery top structure further comprises a second channel formed in the enclosure bottom surface, the second channel extending within the enclosure bottom surface peripheral edge and capable of containing a second electrically conductive material, the second electrically conductive material capable of conducting electrical current between the cathode and the cathode terminal.

In an embodiment of the battery top structure, the electrically conductive material is injectable into the channel. The electrically conductive material is preferably capable of flowing initially as a fluid. The electrically conductive material preferably has a plurality of conductive fragments distributed therein. The plurality of fragments is preferably at least in part particulate.

In an embodiment of the battery top structure, the electrode terminal is configured to connect an electrical load thereto.

In an embodiment of the battery top structure, the battery top interior structure has a plurality of internal channels formed therein, the enclosure having an air-venting through-hole formed therein for enabling fluidly connecting the battery top internal channels and the enclosure bottom surface channel.

In an embodiment of the battery top structure, the enclosure further comprises battery management circuitry. The battery management circuitry preferably comprises a visual display mounted on the enclosure top surface. The visual display preferably comprises at least one light emitting diode. The visual display is preferably numeric.

### DETAILED DESCRIPTION

### Synopsis of the Detailed Description

It is believed that recent improvements and developments in battery chemistry have led to materials that can increase energy storage capacity anywhere from three times up to a theoretical ten times that of the today's best Lithium-ion batteries. The chemistry also allows for far more rapid battery charge times as well. However, some limitations of implementing this new chemistry into current batteries are the conductive limitations of the internal/external wiring, the single-point connections to the internal battery plates, and the surface areas of the connector pins/flats.

The larger the cross-sectional area of the conductor, the more electrons per unit length are available to carry the current, and, as a result, the resistance is lower in larger cross-section conductors. A common approach to enabling greater current loads is to increase the wire diameter (gauge). However, this solution becomes problematic when replacing batteries with higher capacities and faster charge rates within the existing, well-established battery form factors of countless portable batteries.

Recent research has shown that a viable method for overcoming: the above limitations while maintaining, or even reducing, the battery dimensions, is to replace such copper wires/straps with far more ultra-conductive epoxies or sealants that contain a plurality of carbon nanotubes. In theory, nanotubes can carry an electric current density more than 1,000 times greater than copper.

Even an increase of a mere 100 times greater conductivity would result in significantly reducing the cross-section of the conductors and staying within existing form factors, while enabling much faster charge times with related reductions in heat generated by the charging process.

A battery that does not require that its plates be connected internally via single-point solder joints or via conductive-element-filled epoxies to a plurality of wires, allows for alternative battery chemistries to be used which results in a new generation of batteries that have energy density higher than current lithium-ion batteries. Such new batteries can be made from non-toxic components found within the U.S., can undergo far more charge/discharge cycles, be capable of charging in minutes not hours, and do not experience overcharging or polarity switching upon full discharge both of which can cause thermal runaway in lithium-based batteries). Such a new generation of battery represents significant advancements on numerous fronts.

A top structure alleviates the need of wires for internal electrical connections by utilizing interior channels to enable a conductive material to flow freely from the battery connection into the main battery structure. The structures can also be waterproofed. Waterproof batteries are highly desirable in many situations including in devices used in military operations. Furthermore the battery structures can be configured to work with duel battery compartments to increase the voltage/wattage available during charging and/or supply power to two separate devices simultaneously. Certain examples also relate to structures that work specifically with non-lithium-ion based batteries, though battery chemistries using lithium ions can also benefit from this approach.

Certain examples provide a battery that overcomes shortcomings and disadvantages of prior designs by creating battery structures, using additive manufacturing, in particular selective laser sintering (SLS) or stereolithography (SLA), but other types of 3D printing can work as well. Additive manufacturing allows for items to be built layer by layer. This allows for the creation of objects that older technologies such as injection molds require multiple parts to be made which then also require additional assembly processes. Multiple components can be “printed” right onto and essentially into the battery structure without manufacturing separate components and then connecting them via glues, hardware, or other attaching means.

The ability to actually build a battery structure layer by layer, is helpful in creating a battery that is essentially wire-free. This is important as the wires and the way they connect the battery sections together are partly responsible for the large recharging times experienced by current batteries. Batteries created with additive manufacturing as described in this application, or through multi-part assemblies created conventionally, have greatly reduced charging times. Among other benefits, this has enormous implications for electric cars and military devices. The connections also allow different materials to be used that were not compatible with soldering and wiring.

Batteries can now be manufactured with a plurality of individual battery plate channels which have adjoining chambers at opposite sides that can be infused with a conductive epoxy or sealant, down the entire length of the two opposite edges, to connect the envisioned battery plates previously inserted therein.

This epoxy or sealant infusion can contain carbon nanotubes to increase the electrical and thermal conductivity down the entire edge of each battery plate, far beyond that of existing copper wires or straps, connected at single points to each battery plate. This also alleviates manufacturing problems of cold solder joints or incomplete spot connection of common conductive epoxies/sealants.

The charging limitations due to relatively small connectors on the battery and to the charger are further mitigated by dividing the battery into two separate internal sections where the charger input connection can bridge two of the four connections into a series connection such that, for example, a 12V battery can be charged at twice the rate from a 24V charger/connector. The separation of the battery into two internal sections, and the resulting dual-voltage battery systems, can be utilized to divide tasks between the two sections. For example, the low voltage section can run lower power aspects of a device, while the higher voltage section can run energy demanding features. A top structure can employ this knowledge and include a four large pin connector. The connector can also be waterproof. The battery can also be separated into more than two sections.

The insertion of the envisioned battery plates are easily configured within the assembly process to achieve a variety of in-series or in-parallel connections, thus varying the voltage and amperage to achieve a desired output, within the same enclosure. The ability to configure the plates in a standard form internal battery structure makes it uniquely programmable at the time of manufacturing that enables engineers to design products around a battery with a specific voltage, amperage and discharge rate and capacity adjusted to their specific requirements.

Due to the battery structures descried above, new materials can be used in the battery, particularly, but not limited to, metal fluorides such as iron tri-fluoride.

It is believed that using a metal fluoride such as iron trifluoride can result in the battery having up to a tenfold increase in battery power versus the best current lithium-based batteries. Part of this increase is due to the inherit nature of chemical reaction that takes place, and part is due to the fact that metal-fluoride batteries could be fully charged/discharged without worrying about a polarity switch and the resulting thermal runaway.

It is believed that products utilizing metal-fluoride batteries could maintain the same size battery and have up to ten times longer use time. Alternatively companies could decrease a battery size to roughly a tenth of its size and weight and still maintain current use times. This improvement in energy density allows for the creation of smartphones and laptops that can go many more hours between charges, and electric cars that can go hundreds of more miles on a single charge, as well as the creation of other devices that were not commercially feasible with current battery technology.

Additional benefits of moving away from lithium-based batteries include: they are toxic and flammable; the main component, lithium, is a relatively rare and expensive element. On the other hand, the chemicals and elements needed for fluoride batteries are domestically plentiful, non-hazardous/toxic, and relatively inexpensive.

Yet another advantage of moving away from lithium based batteries is the fact that, as mentioned above, lithium batteries cannot handle an overcharge and cannot be fully discharged for fear of polarity switching. Both of these conditions can potentially generate a thermal runaway condition.

Batteries made from other chemicals, such as metal fluorides, do not experience thermal runaway. Furthermore, batteries based on metal-fluorides chemistry should have longer battery lifecycles (potentially up to 10,000 charge cycles compared to the approximately 1,200 charge cycles in current lithium batteries).

Developments in battery chemistry and improvements in the internal structures of batteries, along with advancements made possible by innovations in injection molding and additive manufacturing including selective laser sintering (SLS) and stereolithography (SLA) enables creation of batteries that are vastly more powerful and efficient than current batteries. These newer batteries can be made much smaller and have the same or better performance attributes as their older counterparts. Furthermore, these improvements in battery structure also allow for the creation of a standard form battery that is highly configurable, at the point of manufacturing, to a wide variety of voltages and amps.

It is foreseeable that individuals will desire to utilize these newer and smaller batteries in their current devices and will seek a way to retrofit the devices. One likely problem arises from the availability of batteries in a wide range of configurations, even when serving the same market. For example, there are literally hundreds of different sizes of car batteries. However, since additive manufacturing/advanced injection molding techniques allow for the creation of customized smaller battery enclosures, it makes financial sense to manufacture batteries in a few standardized sizes. Producing batteries utilizing this new technology in the same size as traditional batteries would result in batteries that are ultimately far more powerful than necessary or be more costly to manufacture by having to make their enclosures larger than necessary.

One way to alleviate the potential problem of trying to retrofit a device configured to use a traditional battery of different dimensions than a new standard form factor battery is through the creation of adaptive battery mounting cages. The cage can be created to contain vertical battery mounting inserts which can be slid into the mating grooves on the sides of the new standard form factor battery. Thus a standard form factor battery can be secured and also be easily removed, without the need of tools. The adaptive battery mounting cage itself can be secured using the existing mounting hardware for the traditional battery that is being replaced.

### BRIEF DESCRIPTION OF THE DRAWINGS

FIG. 1 is a perspective view of the battery main enclosure and its internal structure.

FIG. 2 is a top view of the internal battery structure illustrated in FIG. 1.

FIG. 3 is a top view showing battery plates inserted within the battery main enclosure.

FIG. 4 is a cutaway side view showing the internal battery structure.

FIG. 5 is a perspective view of the of a main battery enclosure including the battery top structure.

FIG. 6 is a bottom view of the top structure illustrated in FIG. 1 reveling the otherwise hidden internal channels.

FIG. 7 is a bottom view of the top structure illustrated in FIG. 1 with the internal channels hidden.

FIG. 8 is a perspective view of a main battery enclosure including the top structure with the electrical connector detached.

FIG. 9 is a perspective view of the adaptive battery mounting cage.

FIG. 10 is a perspective view of the battery mount inserts being inserted within a standard form factor battery main enclosure.

FIG. 11 is a perspective view of the battery mount inserts inserted within the standard form factor battery main enclosure.

FIG. 12 is a perspective view of the standard form factor battery fully inserted within the adaptive battery mounting cage illustrated in FIG. 9.

FIG. 13 is a perspective view of the main battery enclosure with sensors and magnets inserted/being inserted into their respective voids.

FIG. 14 is an exploded view of a battery plate configured to be used with the internal battery structure.

### DETAILED DESCRIPTION OF CERTAIN EMBODIMENT(S)

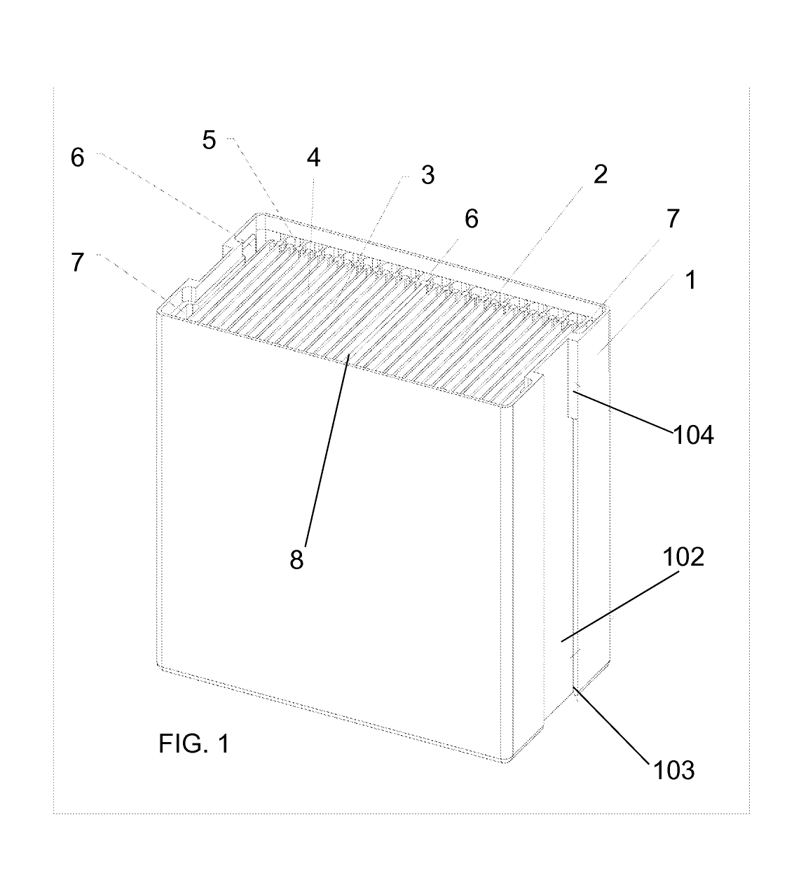

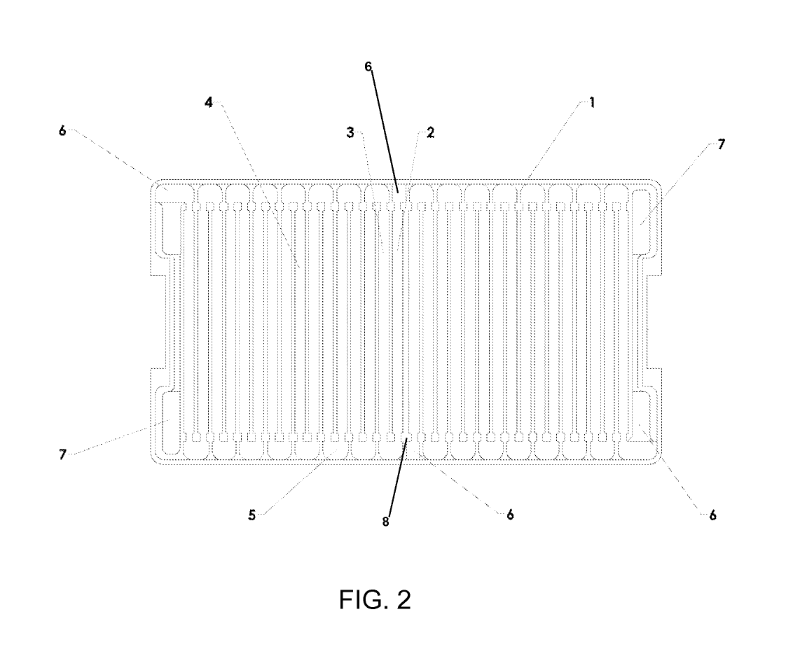

Turning first to FIG. 1 and FIG. 2, a main frame battery structure 1 has two separate battery zones 2 and 3 separated from each other by an (optional) insulating wall slightly offset from the middle 8. Each battery zone is constructed of insulating partitions that form a large serpentine channel. The serpentine structure creates a plurality of battery plate channels 4 and adjoining chambers 5. It is also possible to have only one battery plate channel.

The battery plate channels 4 are appropriate for inserting battery plates (not shown). The adjoining chambers 5 are configured to be filled with an electrical conductive epoxy or sealant that connects the battery plates.

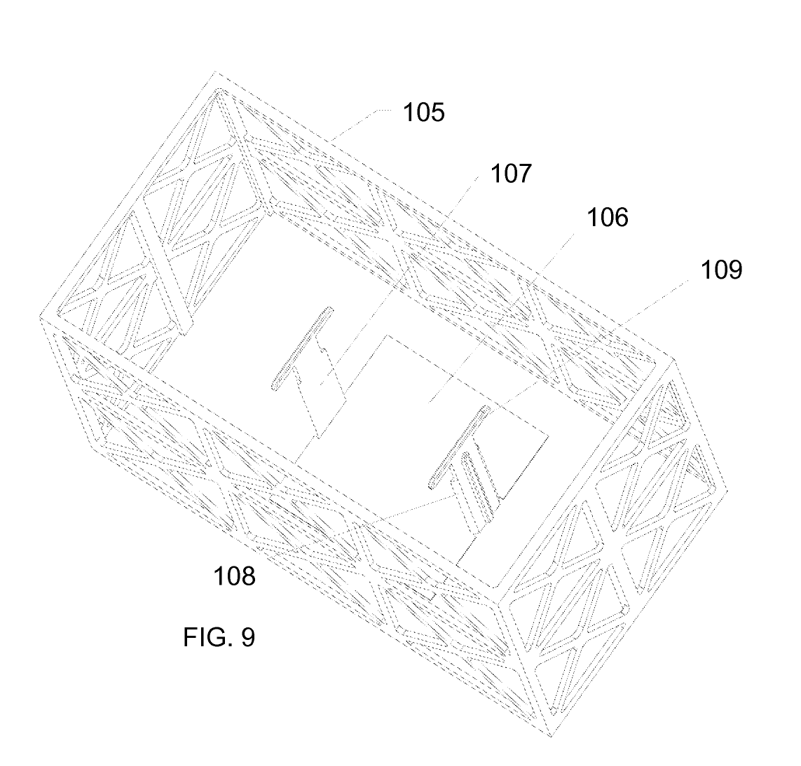

FIG. 1 also shows built in side slots 102 with a section containing angled interior bevels 103 and a separate non-beveled section 104 which can be used to attach the main frame battery structure to an adaptive battery mounting cage 105 (see FIG. 9).

FIG. 2 further illustrates four connection channels 6, with two connection channels shown on the ends on opposite corners plus two connection channels slightly offset from the middle and on opposite sides of the insulating wall 8 configured for filling with the electrically conductive materials to cause the electrical connection to an external connector (not shown).

FIG. 1 and FIG. 2 show two optional sensor channels 7. The sensor channels are configured for inserting diamagnetic sensors (not shown) capable of establishing the battery state of charge/state of health and suitable for filling with an electrically conductive material. This information can be relayed to an attached battery monitoring system.

To improve the readings of the diamagnetic sensors, it can be beneficial to utilize plates made of an electromagnetic interference shielding element. Properly positioning these plates in the internal structure can reduce or eliminate certain magnetic fields that may interfere with the sensors.

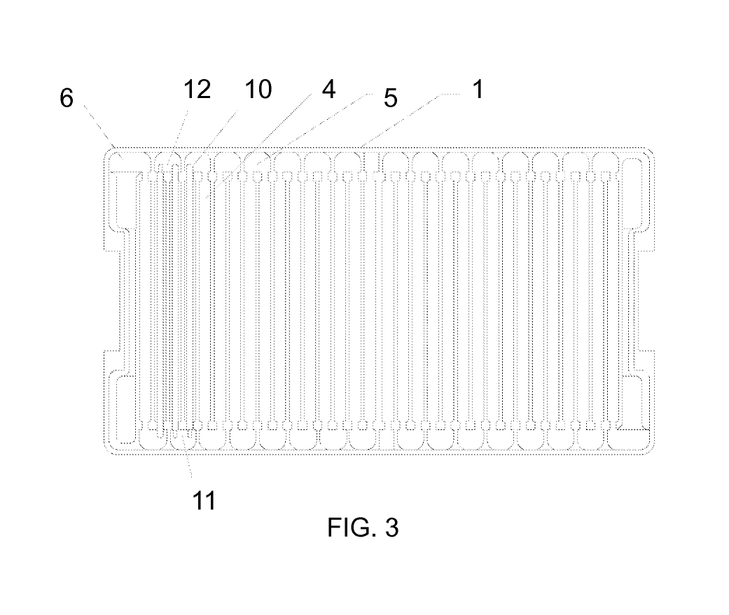

FIG. 3 illustrates the internal battery structure 1 with battery plates 10 inserted into the battery plate channels 4, in a selectable configuration of having the negative anode edge, beside a similarly configured battery plate such that the electrically conductive material connects the plates in a parallel configuration 11. On the opposite end, the cathode material coated edge is set beside the anode edge of another battery plate such that the electrically conductive material connects them in a series configuration 12.

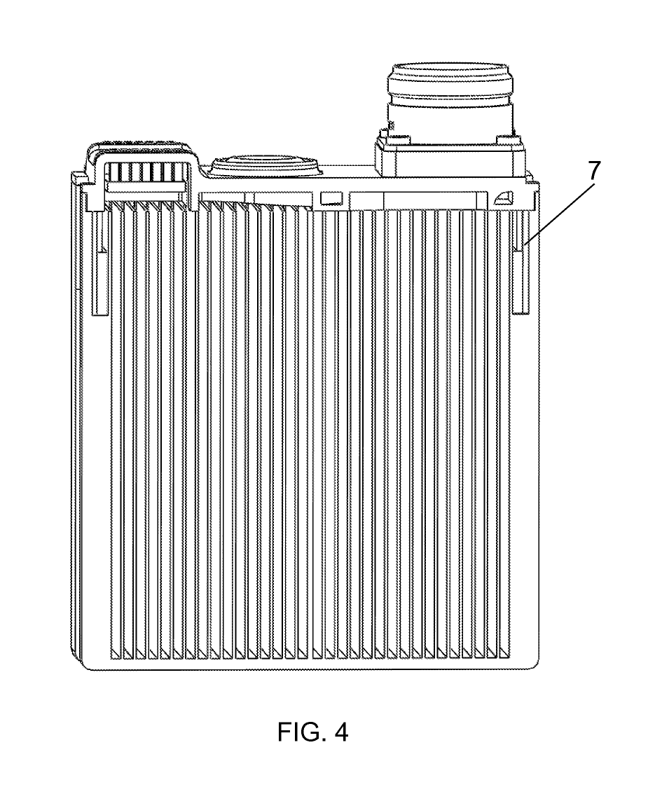

FIG. 4 shows a cutaway of the internal battery structure. From this perspective, it is possible to see the sensor channel 7.

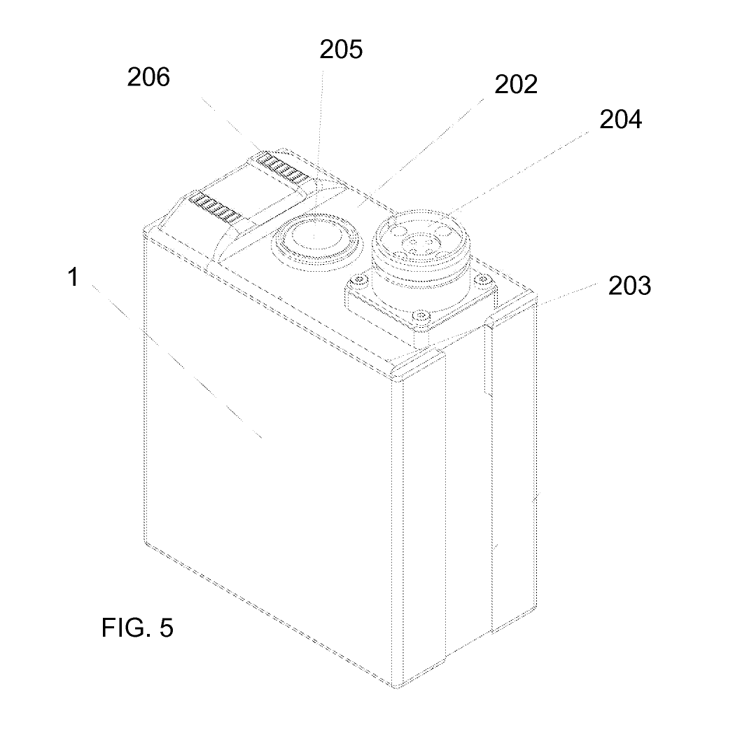

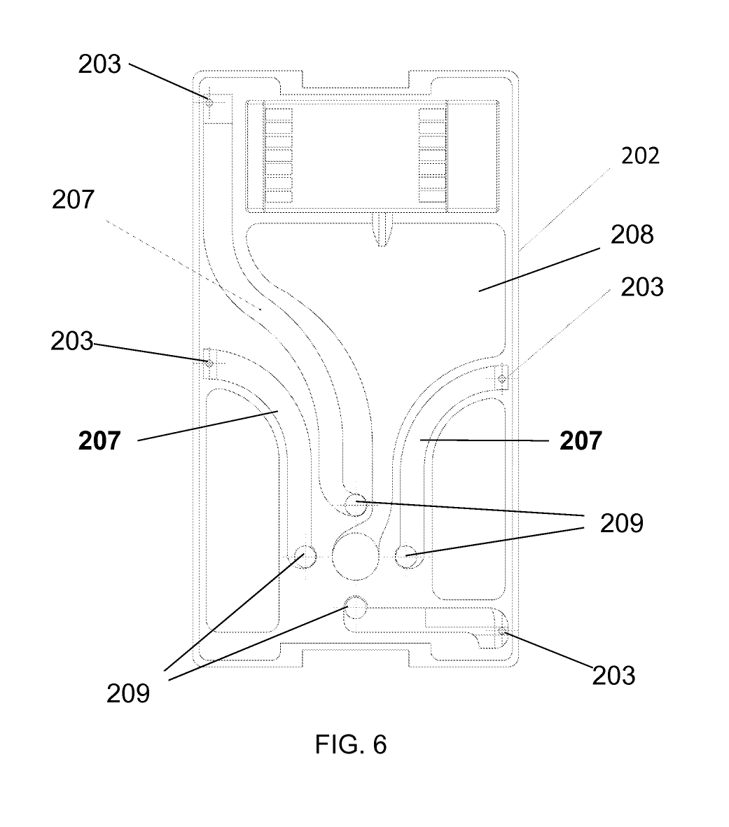

Turning first to FIG. 5, internal battery structure 1 is capped with the battery top structure 202. Four air-venting through-holes 203 are present in the top structure 202 with two shown on FIG. 5 and four shown on FIG. 6 on the ends of opposite corners, plus two slightly offset from the middle and on opposite sides. The air-venting through-holes can allow the free flow of electrically conductive materials into the internal channels 207 located in the top structure 202 (see FIG. 6) as well as into voids in the main battery structure.

FIG. 5 also shows an external electrical connector 204, which has contact connectors 210 (not shown) that enter the internal channels 207 within the top structure 202 (see FIG. 6) and establish electrical connections therein.

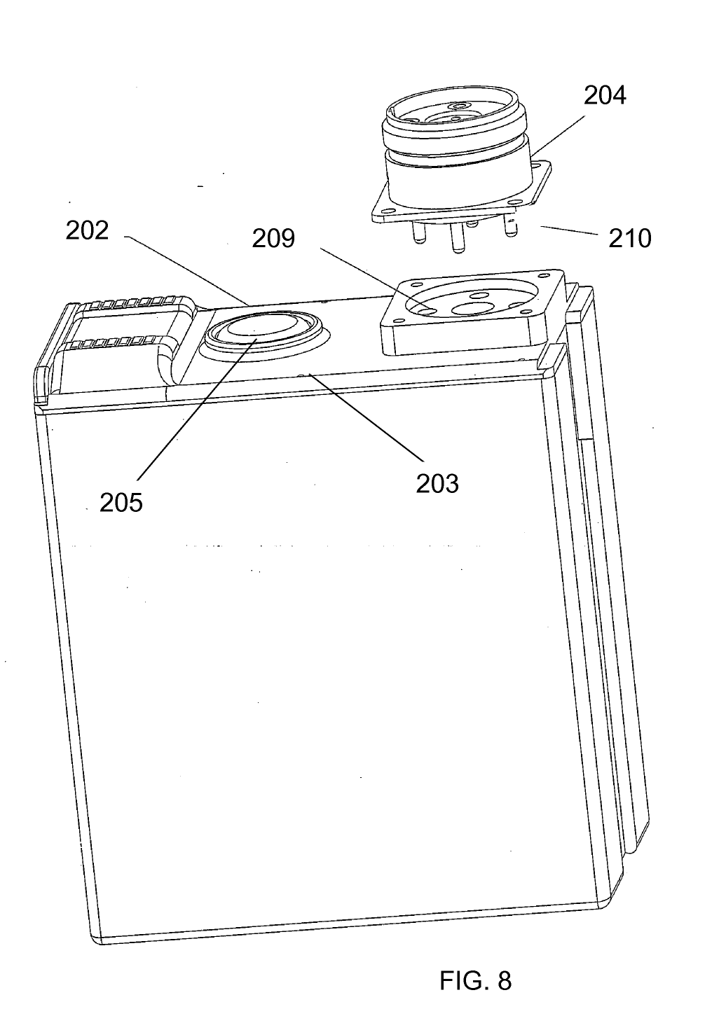

The external electrical connector 204 shown in FIGS. 5 and 8 has four female receptacle inserts to allow the use of dual battery compartments. Dual batteries offer several benefits as described above but an external electrical connector having only two pins for a single battery component is also covered by this application.

In addition, the external electrical connector 204 shown in FIGS. 5 and 8 is waterproof. However, one can use a non-waterproof connector as well.

In addition to the external electrical connector 204, FIGS. 5 and 8 illustrates a waterproof membrane switch 205 which is connected via wires run through internal void 208 (not shown in FIG. 5) to the battery management circuit board 206 which is configured to allow an operator to view the battery charge on a (light-emitting diode) LED or numeric display (not shown).

FIGS. 5 and 8 also illustrate an optional display with a corresponding battery management circuit board 206. In some embodiments display 206 can be LED display and can contain a plurality of externally shown, indicator lights or numeric display (not shown). Among other things, the indicator lights and/or numeric display of display 206 provide a visible indication of battery charge level, battery power output, relative battery charge, rate of battery discharge, rate of battery charging, battery connectivity, battery error, etc.

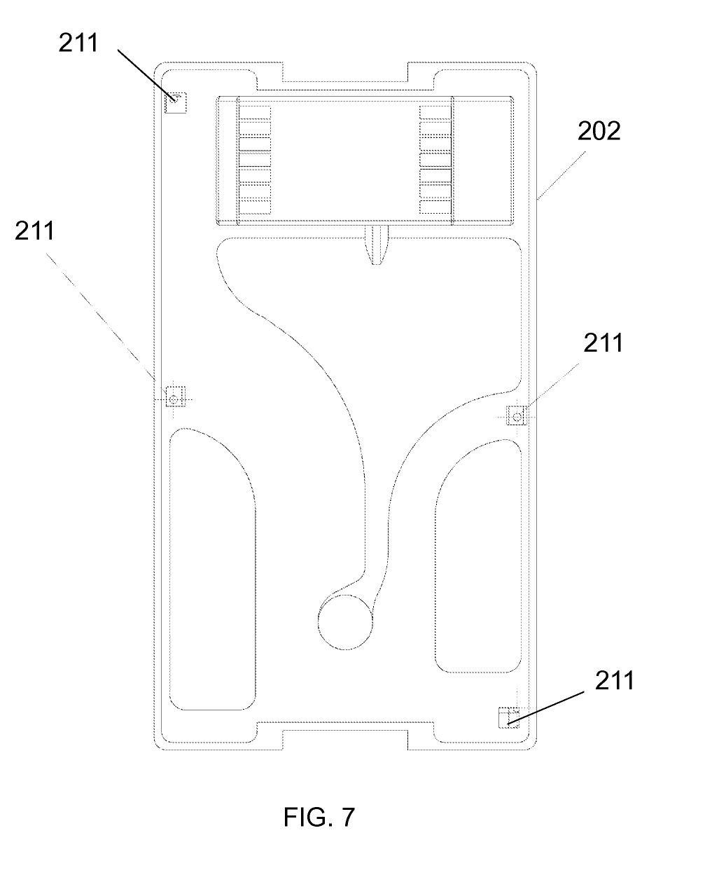

FIGS. 6 and 7 illustrate how the corresponding battery management circuit board 206 (not shown) is connected to the external electrical connector 204 (not shown) via wires run through the internal void 208.

FIGS. 6 and 7 both show bottom views of the top structure 202. FIG. 6 shows the internal channels 207 built into the top structure 202 used for connecting the external electrical connector 204 (not shown). Normally these channels are hidden. FIG. 7 shows the bottom of the battery top structure, as it would look to the naked eye. The four air-venting through-holes 203 (see FIG. 6) allow the free flow of the electrically conductive materials injected into the internal channels 207 via the four conductor holes as well as into voids in the main battery structure (not shown). The electrically conductive material enters the voids via the four exit channels 211 (see FIG. 7)

FIG. 8 shows the top structure 202 and a detached external electrical connector 204. The external electrical connector has four female receptacle inserts that have solid pins 210 which extend downward so as to enter into the matching holes 209 in the top structure 202. These conductor holes 209 can be filled with an electrically conductive material to make a wire-free connection to the battery via the internal channels 207.

FIG. 9 shows adaptive battery mounting cage 105. The cage contains compressible material 106, on which main battery structure 1 sits. The main battery structure can be slid down into the two vertical battery mount inserts 107 and directed and secured along the beveled lower edges 108 within the angled interior bevels of the main frame battery structure 1 (not shown). Then upon hill insertion, T-bar section 109 snaps inward in upper section 104 (not shown) when sufficient pressure has been applied downward along the top of the main frame battery structure into the compressible material 106. The compressible material forces the main frame battery structure 1 upward to secure it against the T-bar 109.

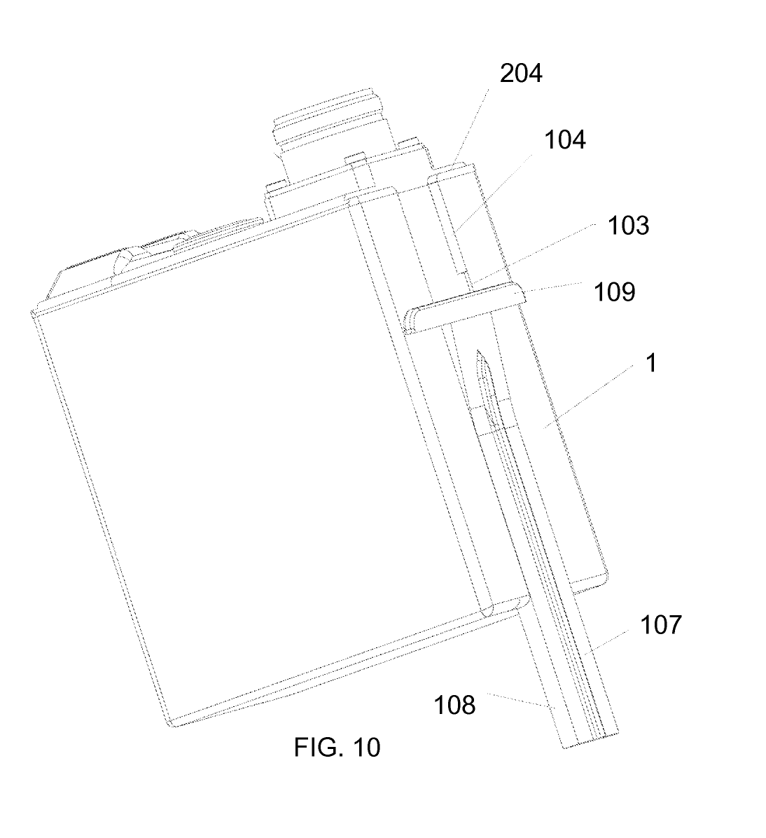

FIG. 10 shows main frame battery structure 1, wherein battery mount inserts 107 are first inserted within side slots 102 and held in position there due to the angled interior bevels of the main frame battery structure 103 and the beveled lower edge of the battery mount insert 108 until the non-beveled section of the battery mount inserts snaps inward into the non-beveled section of the main frame battery structure 4 and the T-bar section 109 sits above the top of the battery 110.

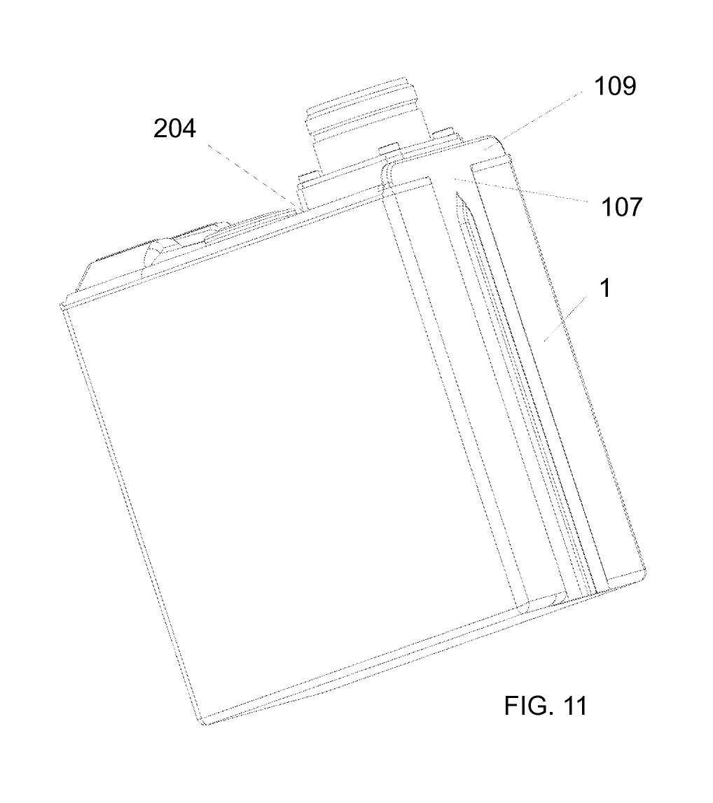

FIG. 11 shows the non-beveled section of the battery mount inserts snapped inward into the Bon-beveled section of the main frame battery structure 104 (not shown) and T-bar section 109 sitting atop top structure 110.

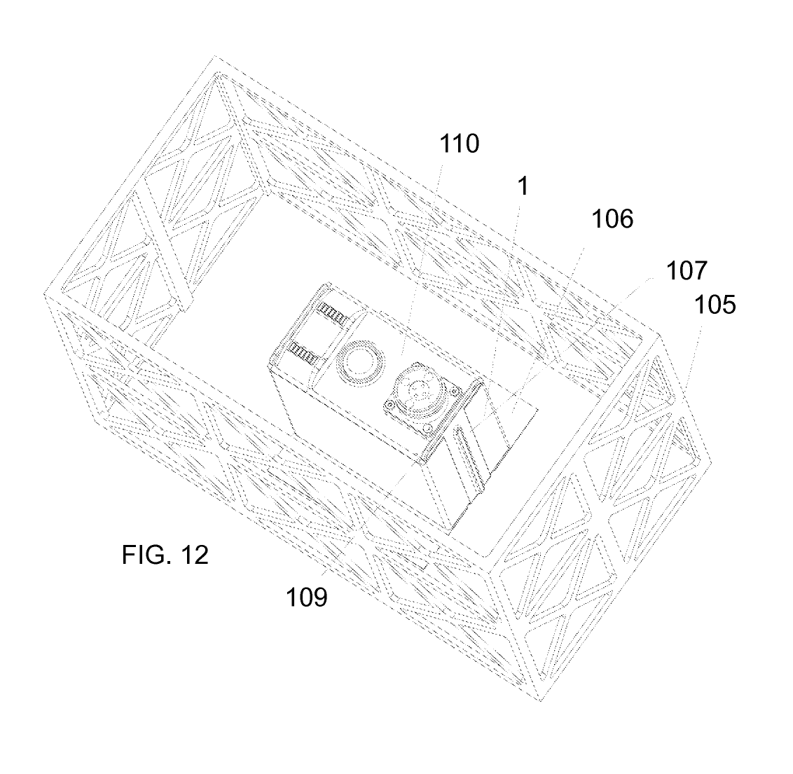

FIG. 12 shows main frame battery structure 1 with the top of the new form battery main enclosure 110, fully inserted in adaptive battery mounting cage 105, wherein battery mount inserts 107 are securing the battery.

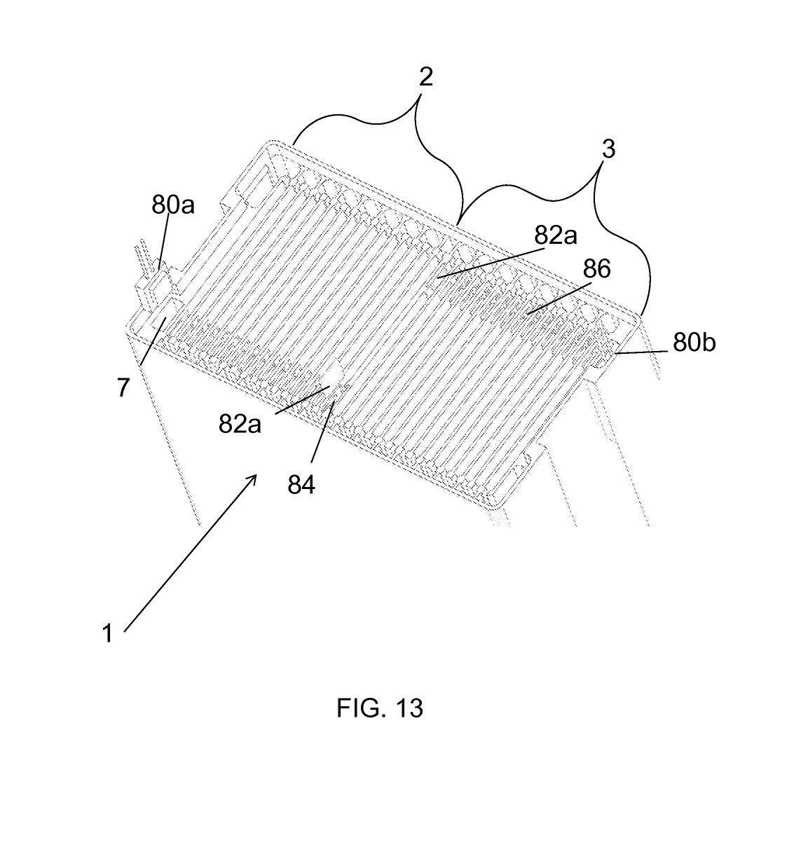

FIG. 13 shows internal battery structure 1 with two separate battery zones 2 and 3. Two optional sensor channels 7 are configured for inserting diamagnetic sensors 80a and 80b capable of establishing the battery state of charge/state of health and suitable for filling with an electrically conductive material. This information can be relayed to an attached battery monitoring system.

Diamagnetic sensor 80a is shown above sensor channel 7, while diamagnetic sensor 80b is shown inserted into a separate sensor channel.

Magnets 82a and 82b can also be placed in magnet voids 84. Magnet 82a is shown above magnet void 84, while magnet 82b is shown inserted into a separate magnet void.

Although the embodiment illustrated in FIG. 13 shows diamagnetic sensors 80a and 80b monitoring zones 2 and 3 respectfully, a single zone battery can also utilize the concept and includes a single sensor and magnet pair.

In certain examples, cutaway sections 86 can be manufactured into internal battery structure 1 so as to reduce interference between diamagnetic sensor(s) 80 and magnet(s) 82. In certain embodiments, multiple magnet voids 84 can be used to allow for the use of multiple magnets 82. Using multiple magnets can be helpful in certain embodiments to boost the magnetic field being read by the diamagnetic sensor(s) 80 to determine the state of charge and/or state of health of the battery.

Being able to readily determine and report the state of health of a battery allows potential users that depend on battery operated machinery, such as first responders, to know whether or not the battery they are using is at the end of its useful life and should and/or needs to be replaced.

The battery state of charge and state of health information can be relayed to an internal and/or external battery monitoring system. The battery monitoring system can use this information along with it making voltage and current measurements during battery charging, discharging and relaxation events to accurately and reliability report on and/or control utilization of the battery.

In other or the same embodiments, multiple sensor channels 7 can also be used to allow for the use of multiple diamagnetic sensors 80 allowing for a more detailed reading of the battery. The use of multiple magnets 82 and/or multiple diamagnetic sensors 80 helps overcome the problem of interference.

Another way to improve the readings of the diamagnetic sensors, is to utilize plates made of an electromagnetic interference shielding element. Properly positioning these plates in the internal structure can reduce or eliminate certain magnetic fields that may interfere with the sensors.

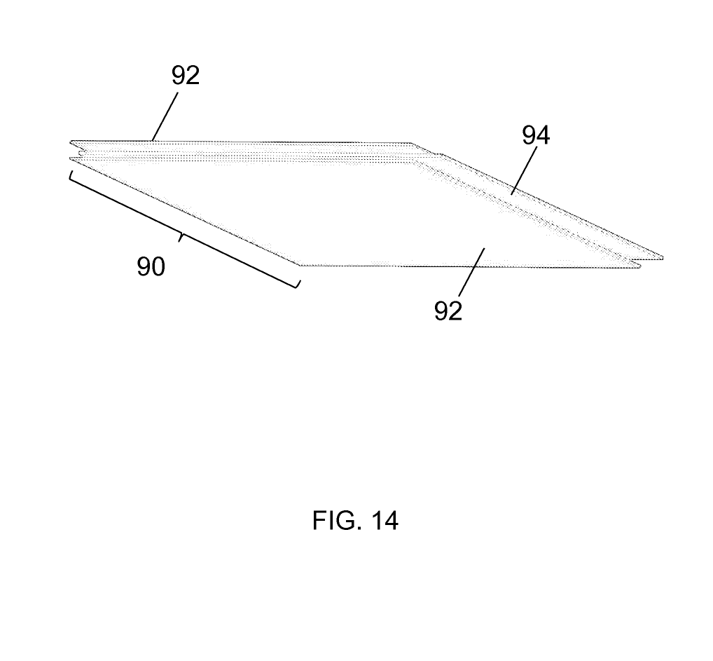

FIG. 14 shows an exploded perspective view of battery plate 90 that can be used with internal battery structure 1 (see FIG. 1). Two cathode plates 92 are pressed into anode plate 94 when cathode plates 92 are still in a gel-like condition. Once pressed together, the two cathode plates 92 solidify creating a three-edge seal. One edge of anode plate 94 is externally exposed. This embodiment, particularly the three-edge seal, helps prevent or at least reduce the likelihood of short outs once the conductive infusion is added.

The conductive infusions extending down the opposite edges of each battery plate 90, reduce the heat generated during charge/discharge in common batteries. In addition, the degree to which the infusion contains carbon nanotubes (which are 9 times more thermally conductive than copper) and/or the infusions extend down the outermost interior void/channels, further enhances the heat minimization and dissipation capabilities. This mitigates the need for various cooling structures/voids/channels, although cooling methods can still be used.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An internal battery structure comprising:
(a) a housing having a floor and a front wall, a back wall and a pair of oppositely disposed side walls extending upwardly from said floor and forming an internal compartment therebetween; and
(h) a plurality of spaced battery plate support walls extending inwardly and alternatingly from said housing side walls, each of said support walls comprising an enlarged portion on its periphery, said support walls defining a serpentine channel extending between said support walls.

2. The internal battery structure of claim 1 wherein said support walls are oriented such that insertion of a battery plate having an optional electrically insulative strip alignable with said support wall enlarged portion electrically isolates interior portions of said serpentine channel disposed between said support wall enlarged portions from the remaining peripheral portions of said serpentine channel adjacent said housing side walls.

3. The internal battery structure of claim 2, wherein said remaining peripheral portions of said serpentine channel are fillable with an electrically conductive material.

4. An internal battery structure comprising:
(a) a housing having a floor and a front wall, a back wall and a pair of oppositely disposed side walls extending upwardly from said floor and forming an internal compartment therebetween;
(b) a first battery zone within said housing internal compartment, said first battery zone comprising a plurality of spaced battery plate support walls alternatingly extending from said housing side walls to define a plurality of first zone serpentine channels;
(c) a second battery zone within said housing internal compartment, said second battery zone comprising a plurality of spaced battery plate support walls alternatingly extending from said housing side walls to define a plurality of second zone serpentine channels; and
(d) a separation wall for fluidly isolating said first zone serpentine channels from said second zone serpentine channels.

5. The internal battery structure of claim 4, wherein each of said support walls comprises an enlarged portion on its periphery such that insertion of a battery plate having an optional electrically insulative strip alignable with said support wall enlarged portion electrically isolates interior portions of said serpentine channels disposed between said support wall enlarged portions from the remaining peripheral portions of said serpentine channels adjacent said housing side walls.

6. The internal battery structure of claim 5, wherein said first battery zone and said second battery zone are configured to generate different voltages.

7. The internal battery structure of claim 5, wherein said first battery zone and said second battery zone are configured to generate the same voltages.

8. The internal battery structure of claim 5, wherein said interior portions of said serpentine channels disposed between said support wall enlarged portions are fillable with a first electrically conductive material and the remaining peripheral portions of said serpentine channel are finable with a second electrically conductive material.

9. The internal battery structure of claim 8, wherein said first and second electrically conductive materials are the same electrically conductive material.

10. The internal battery structure of claim 4, wherein one of said zones is oriented with respect to said housing such that a utility space is defined between said one of said zones and said housing.

11. The internal battery structure of claim 10, further comprising:
(a) battery management circuitry disposed within said utility space; and
(b) a diamagnetic sensor.

12. A battery top structure comprising:
(a) an enclosure for sealing an open portion of a battery having an interior structure comprising at least one electrode, said enclosure having a bottom surface facing said battery interior structure, an oppositely facing top surface comprising an electrode terminal, and an inset peripheral edge, interconnecting said enclosure top and bottom surfaces and facing said battery exterior;
(b) an enclosure with a channel formed within said enclosure, said channel extending within said enclosure to a bottom surface peripheral edge and capable of containing an electrically conductive material, said electrically conductive material capable of conducting electrical current between said electrode and said electrode terminal.

13. The battery top structure of claim 12, wherein said electrode is one of an anode and a cathode.

14. The battery top structure of claim 13, wherein said electrode is an anode, said battery interior structure further comprises a cathode, and said battery top structure further comprises a second channel formed in said enclosure bottom surface, said second channel extending within said enclosure bottom surface peripheral edge and capable of containing a second electrically conductive material, said second electrically conductive material capable of conducting electrical current between said cathode and said cathode terminal.

15. The battery top structure of claim 12, wherein said electrically conductive material is injectable into said channel.

16. The battery top structure of claim 15, wherein said electrically conductive material is capable of flowing initially as a fluid.

17. The battery top structure of claim 15, wherein said electrically conductive material has a plurality of conductive fragments distributed therein.

18. The battery top structure of claim 17, wherein said plurality of fragments is at least in part particulate.

19. The battery top structure of claim 12, wherein said electrode terminal is configured to connect an electrical load thereto.

20. The battery top structure of claim 12, wherein said battery top interior structure has a plurality of internal channels formed therein, said enclosure having an air-venting through-hole formed therein for enabling fluidly connecting said battery top internal channels and said enclosure bottom surface channel.

21. The battery top structure of claim 12, wherein said enclosure further comprises battery management circuitry.

22. The battery top structure of claim 21, wherein said battery management circuitry comprises a visual display mounted on said enclosure top surface.

23. The battery top structure of claim 22, wherein said visual display comprises at least one light emitting diode.

24. The battery top structure of claim 22, wherein said visual display is numeric.
